(19) United States
(12) Patent Application Publication
(10) Pub. No.: US 2021/0097585 A1
(43) Pub. Date: Apr. 1, 2021

(54) PRE-PRINTED POSTAGE APPLICATION

(71) Applicant: Hallmark Cards, Incorporated, Kansas City, MO (US)

(72) Inventors: Jennifer R. Garbos, Kansas City, MO (US); Stephanie F. Young, Overland Park, KS (US)

(21) Appl. No.: 17/034,371

(22) Filed: Sep. 28, 2020

Related U.S. Application Data
(60) Provisional application No. 62/907,717, filed on Sep. 29, 2019.

(51) Int. Cl. G06Q 30/02; G06Q 20/16

(52) U.S. Cl. CPC G06Q 30/0283; G06Q 2250/00; G06Q 20/16

(57) ABSTRACT

Aspects of the technology described herein provide a pre-printed postage. As an initial step, the pre-printed postage is printed on a media, such as an envelope or sticker. Each instance of pre-printed postage comprises a unique identifier encoded in a machine-readable format. Postage is paid for through a payment process. In order to pay for an individual instance of pre-printed postage, the unique identifier encoded in the pre-printed postage needs to be provided to the payment application. At the end of the payment process, a central database is updated to associate the unique identifier with a postal value calculated during payment. When the Postal Service receives an item with pre-printed postage it validates the pre-printed postage and then indicates usage of the pre-printed postage by updating the central database.

### CROSS REFERENCE TO RELATED APPLICATIONS

This application claims the benefit of U.S. Provisional Application No. 62/907,717 filed Sep. 29, 2019.

### BACKGROUND

Postage can be added to an item, such as a letter or package, in a number of different ways. The United States Postal Service (USPS) sells fixed value stamps that may be adhered to an envelope. Franking machines can print postage directly onto an envelope. Customers can go to a kiosk at a post office or other location and receive the correct postage for a package by weighing the package and providing a destination. In these examples, the postage indication, such as a stamp, has a fixed value when printed.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the technology described herein provide a pre-printed postage that can be paid for on-demand. The pre-printed postage has several advantages over postage stamps and on-demand postage printing that is used today, including improved ease of use from a user perspective. Parcels (e.g., envelopes) may come pre-printed with postage that is not paid for in advance by the entity printing the postage on the stamp. The technology described herein allows a user to pay for the postage associated with the parcel through a computer application when the user is ready to post (e.g., mail) the parcel.

As an initial step, the pre-printed postage is printed on a media, such as an envelope or sticker. Initially, the pre-printed postage requires no payment from the carrier and the printing entity will not be responsible for payment until the carrier processes a parcel with the pre-printed postage. Each instance of pre-printed postage comprises a unique identifier encoded in a machine-readable format. The unique identifier may be a string of numbers, letters, a combination of numbers and letters, or some other unique identifier. The unique identifier may be long enough to provide trillions of different unique combinations. The machine-readable format can comprise any method of encoding the unique identifier. Exemplary methods include barcodes, QR codes, a NFC (Near Field Communication) tag, and other RFID (Radio Frequency IDentification) communication technology.

Postage value may be calculated and paid for by an end user through a payment process. The payment process utilizes a computer application running on a computing device. In one aspect, the computing device is a user device such as a smart phone, PC, or tablet. In another aspect, the computing device is part of a kiosk provided in a public location, such as a post office or store. In one aspect, a payment kiosk is provided within or nearby a stationary section of a drug store, grocery store, or other store where greeting cards and other stationary may be purchased.

In order to pay for an individual instance of pre-printed postage, the unique identifier encoded in the pre-printed postage is provided to the payment application. In one aspect, the unique identifier is retrieved by scanning the pre-printed postage. For example, the camera on a smart phone may capture an image of the pre-printed postage. The image can be provided by the camera to the payment application which decodes the unique identifier from the machine-readable format in which it is encoded. In another aspect, a decoding utility on the phone is accessed by the payment application to decode the unique identifier.

Once the unique identifier is obtained from the individual instance of pre-printed postage, the user can provide information about the item to be posted. The information can include a size and weight of the item. Alternatively, the pre-printed application can provide examples for the user to select. For example, a user can be asked to select images of envelopes having different sizes with different amounts of paper in each envelope. Every size combination does not need to be provided, instead representative sizes and amounts of paper can be used to estimate the appropriate postage rate for the item. In one aspect, a UPC label on a greeting card or other item may be scanned to retrieve a size and weight of the item from a database. The payment application may prompt the user to scan the greeting card or other item in order to retrieve a size and weight, postal category, or other information from the database that can be used to calculate the postage rate. The user may also be asked to provide a destination address. In one aspect, the payment application includes the ability to read handwriting. In this instance, the destination address could be obtained by scanning the address listed on the item. In another aspect, the user provides the ZIP Code of the destination.

Once the item information is provided, the postage rate is calculated. The user may be asked to confirm the amount or authorize payment in the amount of the calculated postage rate. Once confirmation is obtained, the application sends a message to a central postage database. The central database is updated to associate the unique identifier with a postal value equal to the postage rate. Other information may also be included within the database, such as a destination ZIP Code. The central postage database may be managed by the entity printing the postage and/or taking payment. In one aspect, the central postage database is not managed by the delivery service (e.g., the postal service). The delivery service may be given access to the central postage database in some aspects.

When the delivery service receives an item with pre-printed postage it validates the pre-printed postage as acceptable postage using information included on the postage. The delivery service can extract the encoded unique identifier from the pre-printed postage. The unique identifier may be extracted by scanning the pre-printed postage and providing the information obtained to a decoding utility. The unique identifier may be recorded in a database. Other information about the item, such as a calculated postage amount or destination address may also be recorded in the database. The postage may be validated as valid postage based on the overall appearance of the pre-printed postage, including various visible design elements. The database record can be used to bill the entity that printed the pre-printed postage or is otherwise associated with the encoded unique identifier.

### BRIEF DESCRIPTION OF THE DRAWINGS

Aspects of the invention are described in detail below with reference to the attached drawing figures, wherein:

FIG. 1 is a block diagram of an example process flow for printing, in accordance with an aspect of the technology;

FIGS. 1A-1F are a block diagrams of an example process flow for printing, paying for, and using pre-printed postage, in accordance with an aspect of the technology;

FIG. 2 is a flow chart showing a method for printing, paying for, and using pre-printed postage, in accordance with an aspect of the technology;

FIGS. 2A-F are a flow charts showing a detailed view of a method for printing, paying for, and using pre-printed postage, in accordance with an aspect of the technology;

FIG. 3 is a sequence diagram showing a method of paying for pre-printed postage, in accordance with an aspect of the technology;

FIG. 4 is a diagram showing exemplary incentives for using pre-printed postage, in accordance with an aspect of the technology;

FIG. 5 is a diagram illustrating contacts who have received letters mailed with pre-printed postage, in accordance with an aspect of the technology;

FIG. 6 is a diagram illustrating a graphical encouragement for using pre-printed postage, in accordance with an aspect of the technology;

FIG. 7 is a diagram illustrating a graphical encouragement for using pre-printed postage, in accordance with an aspect of the technology;

FIG. 8 is a diagram illustrating a graphical encouragement for using pre-printed postage, in accordance with an aspect of the technology;

FIG. 9 is a block diagram of an example operating environment suitable for implementing aspects of the technology;

FIG. 10 is a diagram depicting an example computing architecture suitable for implementing aspects of the technology;

FIG. 11 depicts a flow diagram of a method for paying for pre-printed postage, in accordance with an aspect of the technology;

FIG. 12 depicts a flow diagram of a method for processing pre-printed postage, in accordance with an aspect of the technology;

FIG. 13 depicts a flow diagram of a method for printing pre-printed postage, in accordance with an aspect of the technology; and

FIG. 14 is a block diagram of an exemplary computing environment suitable for use in implementing an aspect of the technology.

### DETAILED DESCRIPTION

The subject matter of aspects of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the technology described herein provide a pre-printed postage that can be paid for on-demand. The pre-printed postage has several advantages over postage stamps and on-demand postage printing that is used today, including improved ease of use from a user perspective. Parcels (e.g., envelopes) may come pre-printed with postage that is not paid for in advance by the entity printing the postage on the stamp. The technology described herein allows a user to pay for the postage associated with the parcel through a computer application when the user is ready to post (e.g., mail) the parcel.

As an initial step, the pre-printed postage is printed on a media, such as an envelope or sticker. Initially, the pre-printed postage requires no payment from the carrier and the printing entity will not be responsible for payment until the carrier processes a parcel with the pre-printed postage. Each instance of pre-printed postage comprises a unique identifier encoded in a machine-readable format. The unique identifier may be a string of numbers, letters, a combination of numbers and letters, or some other unique identifier. The unique identifier may be long enough to provide trillions of different unique combinations. The machine-readable format can comprise any method of encoding the unique identifier. Exemplary methods include barcodes, QR codes, a NFC (Near Field Communication) tag, and other RFID (Radio Frequency IDentification) communication technology.

Postage value may be calculated and paid for by an end user through a payment process. The payment process utilizes a computer application running on a computing device. In one aspect, the computing device is a user device such as a smart phone, PC, or tablet. In another aspect, the computing device is part of a kiosk provided in a public location, such as a post office or store. In one aspect, a payment kiosk is provided within or nearby a stationary section of a drug store, grocery store, or other store where greeting cards and other stationary may be purchased.

In order to pay for an individual instance of pre-printed postage, the unique identifier encoded in the pre-printed postage is provided to the payment application. In one aspect, the unique identifier is retrieved by scanning the pre-printed postage. For example, the camera on a smart phone may capture an image of the pre-printed postage. The image can be provided by the camera to the payment application which decodes the unique identifier from the machine-readable format in which it is encoded. In another aspect, a decoding utility on the phone is accessed by the payment application to decode the unique identifier.

Once the unique identifier is obtained from the individual instance of pre-printed postage, the user can provide information about the item to be posted. The information can include a size and weight of the item. Alternatively, the pre-printed application can provide examples for the user to select. For example, a user can be asked to select images of envelopes having different sizes with different amounts of paper in each envelope. Every size combination does not need to be provided, instead representative sizes and amounts of paper can be used to estimate the appropriate postage rate for the item. In one aspect, a UPC label on a greeting card or other item may be scanned to retrieve a size and weight of the item from a database. The payment application may prompt the user to scan the greeting card or other item in order to retrieve a size and weight, postal category, or other information from the database that can be used to calculate the postage rate. The user may also be asked to provide a destination address. In one aspect, the payment application includes the ability to read handwriting. In this instance, the destination address could be obtained by scanning the address listed on the item. In another aspect, the user provides the ZIP Code of the destination.

Once the item information is provided, the postage rate is calculated. The user may be asked to confirm the amount or authorize payment in the amount of the calculated postage rate. Once confirmation is obtained, the application sends a message to a central postage database. The central database is updated to associate the unique identifier with a postal value equal to the postage rate. Other information may also be included within the database, such as a destination ZIP Code. The central postage database may be managed by the entity printing the postage and/or taking payment. In one aspect, the central postage database is not managed by the delivery service (e.g., the postal service). The delivery service may be given access to the central postage database in some aspects.

The payment process on a public device can differ from the payment process on a private device. On a private device, the user will establish an account when downloading and installing the application. The user account may be linked to a payment method, such as a credit card, PayPal, Apple pay, a prepaid postage account, or other electronic payment mechanism. Once the application is set up, the user may not need to provide any additional user/payment information during subsequent uses of the postage payment process.

In contrast, on a public device, such as may be found in a kiosk, the user may be asked to login if the user already has a postage account. If the user does not already have an account, the user may need to create an account or at least provide enough information to complete a payment process. Once payment is made, the user may deposit the item with the Postal Service or other carrier.

When the delivery service receives an item with pre-printed postage it validates the pre-printed postage as acceptable postage using information included on the postage. The delivery service can extract the encoded unique identifier from the pre-printed postage. The unique identifier may be extracted by scanning the pre-printed postage and providing the information obtained to a decoding utility. The unique identifier may be recorded in a database. Other information about the item, such as a calculated postage amount or destination address may also be recorded in the database. The postage may be validated as valid postage based on the overall appearance of the pre-printed postage, including various visible design elements. The database record can be used to bill the entity that printed the pre-printed postage or is otherwise associated with the encoded unique identifier.

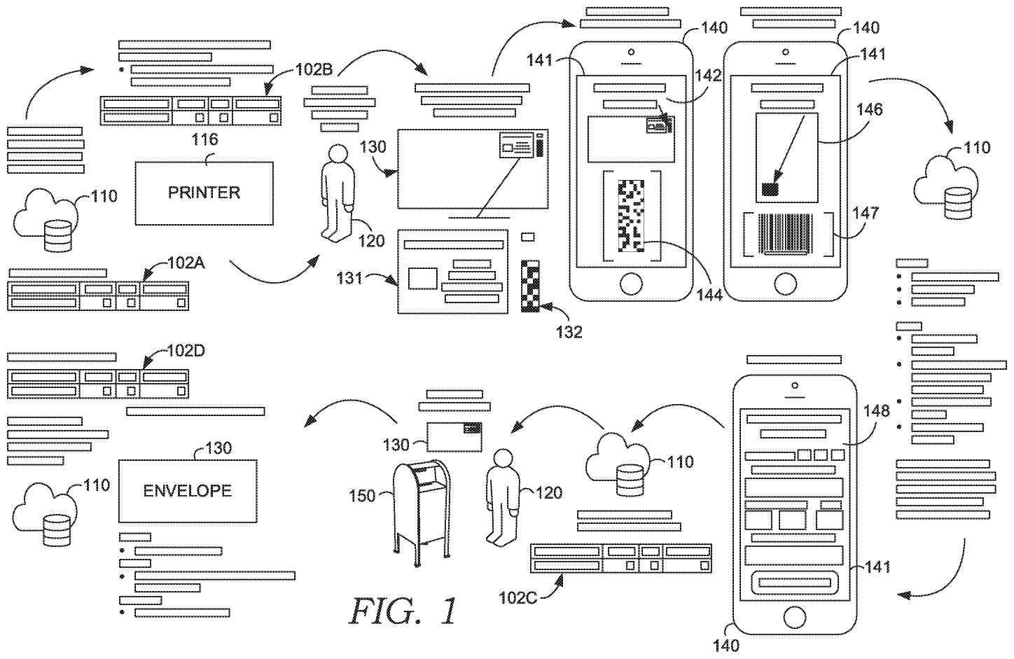

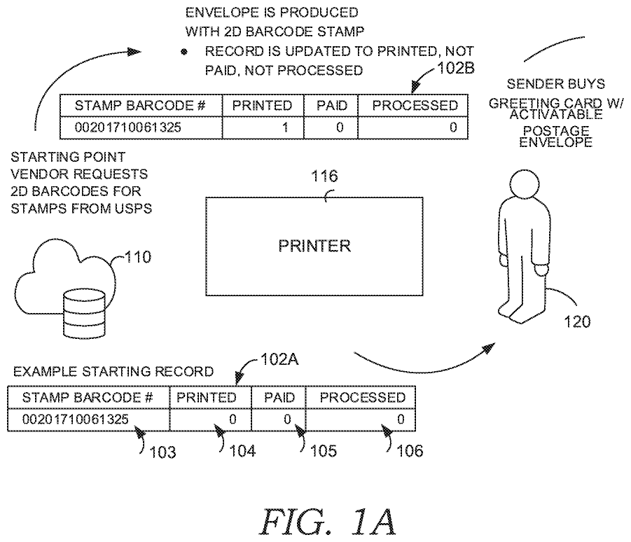

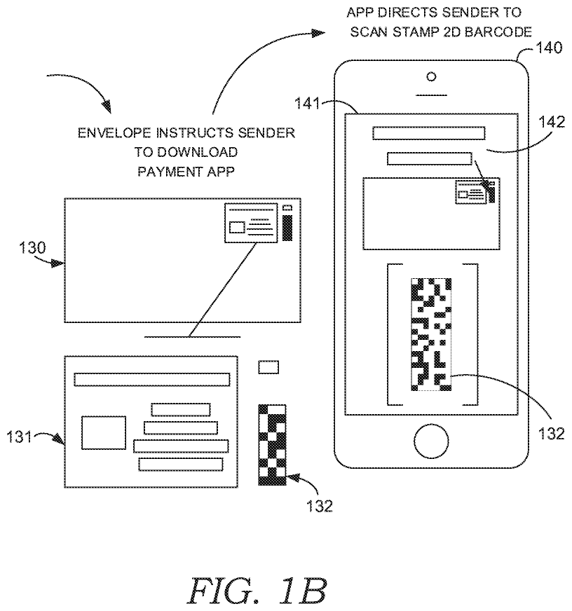

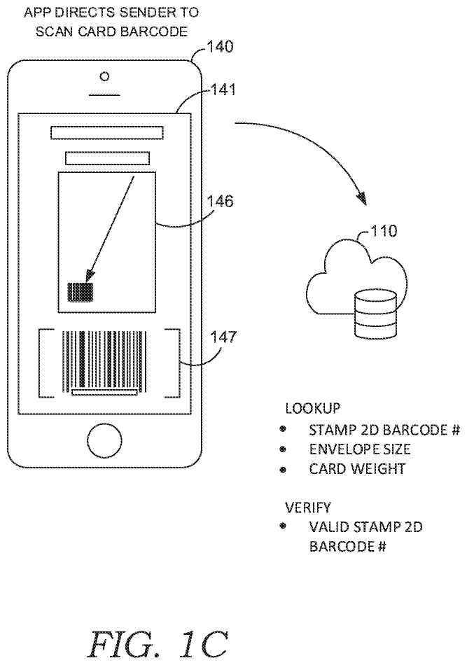

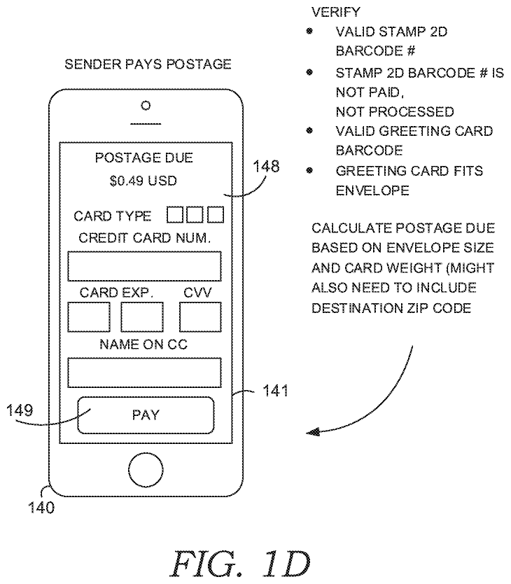

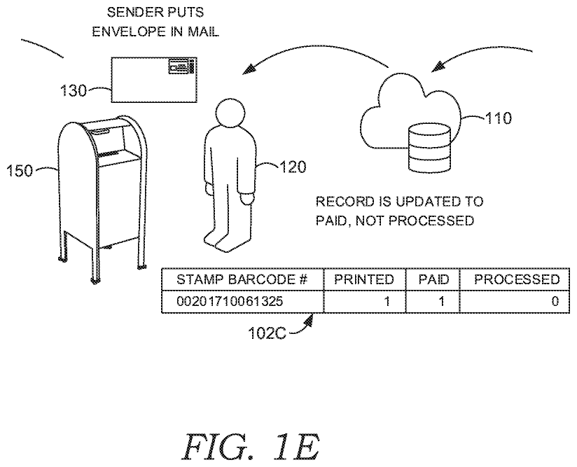

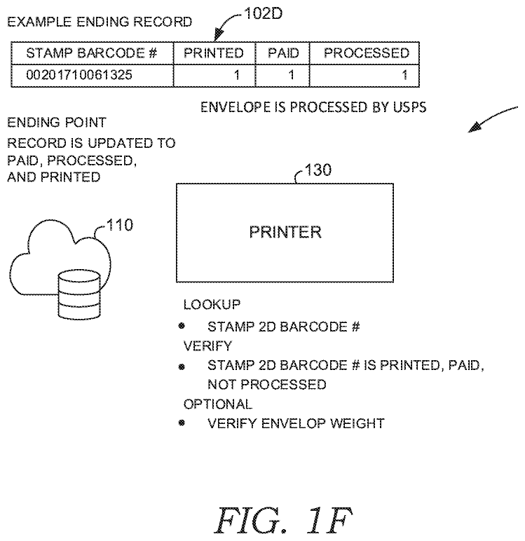

Various implementations are described with reference to FIGS. 1-3. In an aspect, a traditional stamp is replaced with a unique object or code (e.g., a QR code, a UPC code, a digital tag like an NFC (Near Field Communication) device or other RFID (Radio Frequency IDentification) communication technology, or the like) that is read by a user's phone. The phone includes a mobile postage application (“app”) that scans the code, allows the user to calculate and pay the desired/required postage, use the code as postage detectable by a mail courier that will take the item from the sender/gift giver to the recipient/gift receiver, and follow the progress of the item along its path to the recipient/gift receiver.

In one embodiment, the technology described herein may take the form of a unique QR code (or other UPC code or digital tag like NFC) place or printed in the upper right-hand corner of an envelope. The manufacturer of the envelope does not have to pay the postage at the time of manufacture (e.g., printing) and the purchaser of the envelope does not have pay the cost of the postage (which could be unknown at the time of the purchasing of the envelope) at the time of envelope purchase. The code need only be unique, such that it may be tied to that particular envelope.

When the purchaser or possessor of the envelope desires to use it to send the envelope via mail (e.g., First Class mail via the U.S. Postal Service) or other courier service (e.g., an overnight delivery service, such as UPS, FedEx, or some other service that transports items, such as messenger service, Uber drivers, airlines, trucking companies, individuals, etc.), that person scans the QR code with their phone and a mobile postage app is activated that allows them to pay for the postage for this unique envelope. The mobile postage app integrates the scanning feature (whether QR, UPC, NFC, etc.) with a prompt to the user to enter or scan the destination zip code or address printed or written on the front of the envelope. This can be done manually or by taking a photo of the front of the envelope and character recognition software used to enter the destination address into the app.

The user could also be prompted to enter in information about the item being placed in the envelope. In this example embodiment, the contents of the envelope is a greeting card. Accordingly, the user could scan, with the camera of their phone in the app, the UPC of the greeting card. This information could then be sent through the app to a database which contains information on the specifics of the card, including size and weight. The card specifics can be sent back to the app to allow the app to calculate the desired postage needed at the then current rates of the mail or courier service being used to transport the envelope from its current location (which, if relevant, can be determined by the GPS location of the phone or entered manually by the user) to the destination.

The app would then present the user with the calculated amount and prompt the user to confirm they want to use the calculated amount or add additional postage if they have modified the package in some way. For example, if the user placed photographs or gift cards in the greeting card, the user would select the option to add additional postage to cover the increased weight. Similarly, the user could add increased postage, in some instances, to increase the speed at which the envelope is moved along its route (e.g., overnight vs. standard ground transportation). The app could prompt the user with these choices and options and help them determine the additional amount needed. The postage calculated by the application need not match the postage charged to the vendor by the delivery service. For example, a flat bulk rate could be negotiated by the vendor with the delivery service and the consumer charged the going rate for postage by the delivery service.

Once the postage is determined, the user is prompted to pay the postage calculated via their mobile device. This could be done, for example, via a credit card payment. The user may have a credit card stored in the mobile postage app or they may scan their credit card via the camera of their phone through the app which captures the information via character recognition technology. Other means for payment in a mobile environment are possible and contemplated and within the scope of the technology described herein.

Once the payment has been made, the QR code is associated with an indication that it has been paid for. The QR code identification details, along with the purchase details, including postage, are transmitted from the application to a vendor database (e.g., centralized postage database). In one example, the fact that paid postage is associated with the QR code could be communicated to the USPS (or other delivery provider). The USPS could then enter this information into their database of valid codes so that when the envelope is scanned and sorted through existing postal systems, once the user puts the package (e.g., envelope) in the postal stream, the QR code would be recognized as valid postage and the envelope would be delivered to its destination. In another aspect, the delivery service provides valid codes in the first place and these codes are entered into the vendor database. The delivery service can maintain a separate database of valid codes and code usage. The money collected through the alternative postage purchase process, or a portion thereof, would then be transferred to the appropriate mail or courier service, so they are paid for transporting the envelope. In another aspect, the QR code encodes a value the postal service will consider valid at the time of printing. The postal service will scan the QR code upon receipt and charge the vendor when the package with the QR code is scanned. The QR code and corresponding charge could be provided to the postage vendor.

Turning now to FIG. 1, a graphical overview of an exemplary version of the technology described herein, is disclosed. FIG. 1 is broken into smaller portions that are enlarged and provided as FIGS. 1A-1F. FIG. 1A discloses a “starting point” of the illustrated embodiment. Here an envelope manufacturer requests unique 2D barcodes, QR codes, or other unique indicia from an entity that will eventually be carrying the envelope, such as the USPS. For simplicity, the codes will be described a 2D barcodes in several places, but aspects are not limited for use with 2D barcodes. The unique 2D barcodes are stored in a database 110. In one embodiment, the database contains additional information associated therewith relating to the status of the barcode. In the illustrated embodiment, this is shown as a table or a “starting record” with various fields. The fields may include information on the barcode, such as a “valid,” “paid” status indicator and a “processed” status indicator. A “1” can correspond to yes, while a “0” correspond to no. Thus, the starting record 102A shows the code 103 is received, but not printed 104, paid for 105 or processed 106. The information associated with the barcode can also include information on the size of the envelope upon which the barcode was placed. This can be used later for calculating the postage required.

It is worth noting that, in another embodiment, the envelope manufacturer may generate their own unique codes that they later provide to the various carrying/delivery services.

Turning back to FIG. 1A, once the envelope 116 is made with a barcode printed thereon, the database record 102B is updated to indicate the barcode has been used (i.e., printed is on an envelope). It, however, is not yet paid for, nor has the barcode been used as a stamp. The envelope with the barcode is then put in the stream of commerce where a “SENDER” 120 purchases the envelope 116, perhaps along with a greeting card. It should be noted that the envelopes could be sold without accompanying items such as greeting cards. Users could buy envelopes with pre-printed postage for sending their regular mail In this manner, they would never need to go purchase stamps, as they could simply pay for them when needed and the then current postage rate could be applied.

In FIG. 1B, we see that where one would normally place a stamp (i.e., in the upper right-hand corner) a visual marker 131 is placed to convey to the user of the envelope 130 that the envelope doesn't need a stamp but that the user may use the visual marker 131 as a stamp. The visual marker may include stamp-like graphics, logos, and other items. It will also include the barcode 132. Again, as discussed above, the barcode 132 could be any number of items, instead of the QR code illustrated. It should be noted that a less identifiable code could be used. For example, the crown in the illustrated visual marker could be embedded with coding detectible to the app's scanner, but not readily perceptible to a human user (i.e., it is a machine readable code that is not perceptible as such by the human eye). The appearance of the visible machine code, however, may be useful in conveying to users that it is to be scanned and where to scan.

The user downloads to a computing device 140 the mobile postage app associated with a postage vendor and installs the same. When the app is opened the user has the option to proceed with the process to pay for a “stamp” or envelope. One step in that process is to scan the barcode of the envelope. The GUI 141 may graphically direct 142 or illustrate to the user the portion of the visual marker they are to scan. Once the barcode 132 is scanned, that information may be transmitted to the database.

While not illustrated (as it is not necessary in this embodiment), the user may also be prompted to enter information about the destination of the envelope, as this may affect the postage due. The user could key in the information manually though a keyboard displayed on their phone, use speech-to-text voice recognition, or may use the same camera and scanning process used to capture the barcode to capture the address written on the front of the envelope. The app can include character recognition software to identify the letter and numbers in the image to enter destination information, such as city and zip code. This can be used in the relationship app later, in addition to being used in fee calculation. A further step could be provided to give the user the ability to speed up the delivery process by paying an increased fee (e.g., for overnight delivery when used with such couriers). Since the illustrated embodiment is for domestic use of first class mail, the destination information is not necessary to obtain, as it doesn't affect the postage needed.

In FIG. 1C, the user is instructed 146 to provide information about what is being sent inside the envelope. Where, as here, the user is sending a greeting card in the envelope, the user may provide information about the contents simply by scanning the UPC 147 of the greeting card. That information is sent to a database 110 which collects details on the card being sent, including the size and weight of the card. The contents information is then sent to the database as well. This is the “Lookup” step. The verification process begins, including checking with the database to confirm the QR code 132 is valid.

The remaining “verify” steps are shown in FIG. 1D. Verification/confirmation that the barcode is valid includes the fields showing the barcode is printed, not already paid for, and not already used in a mailing. This step can also determine other information, such as whether the scanned greeting card will fit in the envelope being activated.

Once the verification process has occurred, the app 141 uses the gathered information, along with the known information on costs provide by the courier of the envelope, to determine the postage due. The calculated postage due 148 is displayed to the user and they are prompted to pay 149 the amount through the app. In the illustrated embodiment, a user is prompted to enter their credit card information. This information can be stored in the app for later purchases. Alternatively, the same camera and scanning process used above can be used to scan (i.e., capture an image of) the user's credit card and the character recognition software can determine the numbers/characters and enter them for the user. Any other online or electronic payment options and payment verification methods may be used at this step. Once the information is entered, the user indicates they want the postage paid, in this case by pressing the “PAY” icon 149.

The application may provide an interactive user interface to collect information that can be used to calculate the postage due. For example, the menu could ask the user to indicate whether a gift card is being included with the greeting card. Another menu item could ask how many sheets of paper are being included in the envelope and use that information to calculate the correct postage. The sheets of paper could be included with a greeting card or without. Either way the information can be used to calculate the correct postage. In one aspect, the interface can ask for the weight of the item(s) being posted.

Once activated, the user 120, in FIG. 1E, hands the envelope 130 over to the courier, which, in this case, is putting the envelope in a USPS mailbox 150. Also, upon payment, the record 102C associated with the barcode in the database is updated to indicated the barcode is paid.

FIG. 1F illustrates the envelope 130 passing through the USPS system. Here, the barcode is scanned by a postal machine. The encoded identifier in the barcode can include both an identifier for an entity responsible for the pre-printed postage and a unique identifier for the instance of pre-printed postage. The postal system can also verify that the weight of the envelope is the proper amount for the postage that was paid. If the envelope is heavier than the amount calculated, the envelope may again be treated like any other piece of mail with insufficient postage. The postal system can also just provide the postage amount without checking the postage paid by the user. When everything is correct and verified, the envelope 130 is sent on for delivery and the database record 102D is updated to show the barcode was processed (i.e., already used—the equivalent of a cancelled stamp).

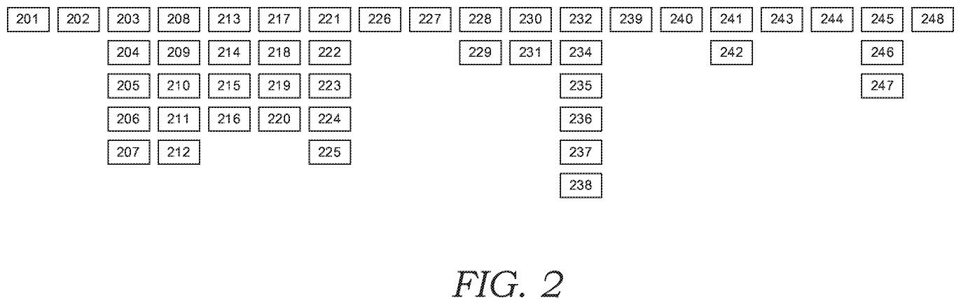

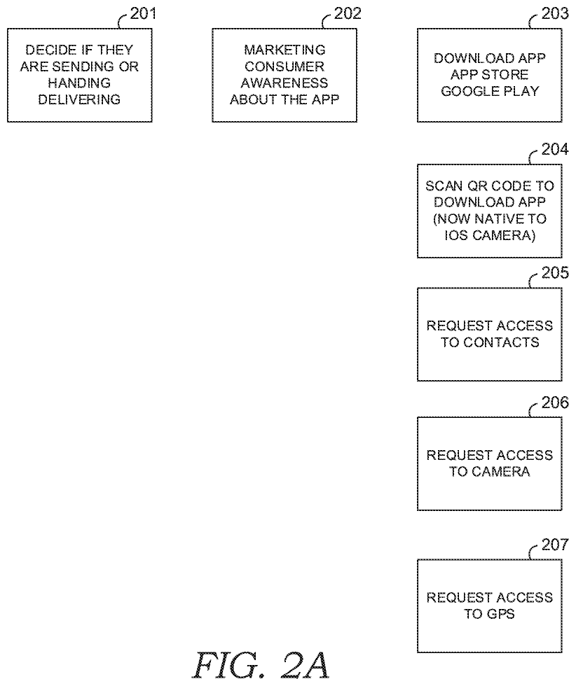

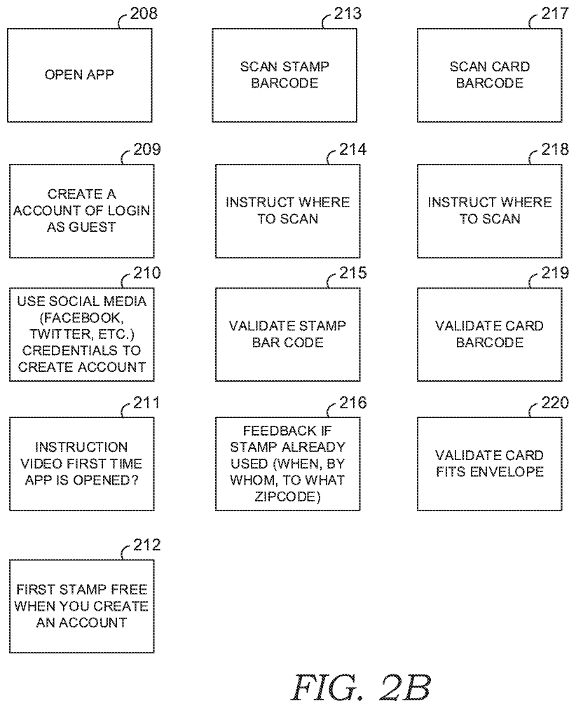

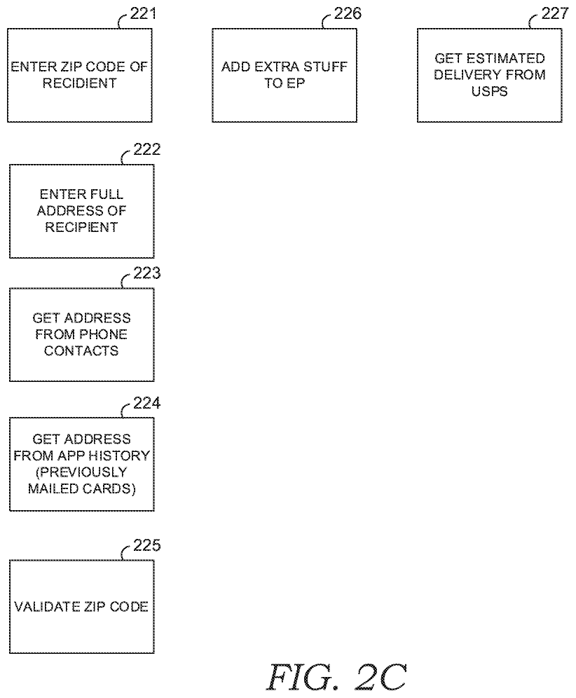

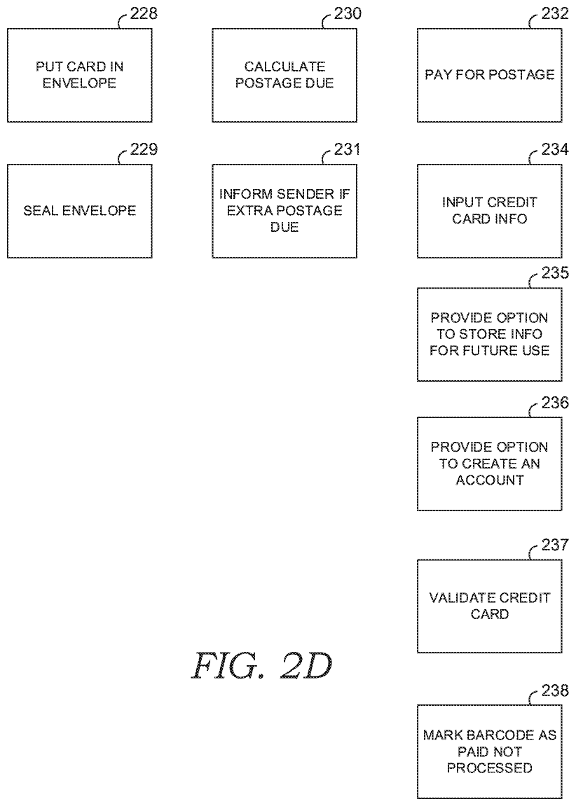

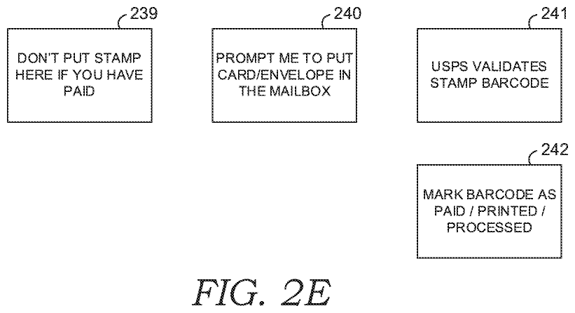

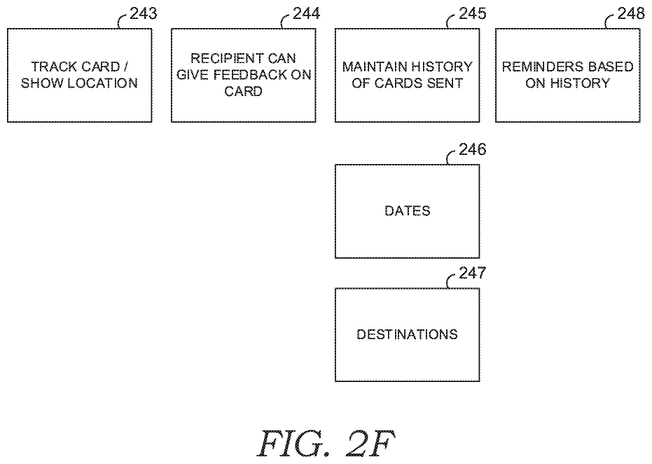

FIG. 2 is a flow diagram showing a method 200 for paying for postage, according to an aspect of the technology described herein. FIG. 2 is broken into smaller portions that are enlarged and provided as FIGS. 2A-2F. Turning now to FIG. 2A, at step 201 the user decides whether to send the envelope via mail (i.e., he needs to pay for postage) or hand deliver the card to someone. The technology described herein allows for such an option, whereas pre-paid postage requires the user to pay for the postage at the time of purchase, whether they will use it or not, and without knowing if they will need additional postage. Here, there are no upfront costs and costs are only incurred if the user decides to pay for the postage.

At step 202, consumer awareness marketing of the app and the alternative postage option is performed.

At step 203, the user may then download the app or access a web site. This can be done manually by navigating to a webpage or searching for the app in an app store. At step 204, the postage payment app can be accessed by scanning the pre-printed postage with a camera on a smart phone, table, or other device on which the application is installed. In this way, the barcode can serve as both pre-printed postage and a guide to find and download the application needed to activate the postage. In one aspect, the barcode comprises two different barcodes encoding different information. One barcode can encode the pre-printed postage identifier and the other the app identifier. While installing the app, standard app set up questions may be asked to access a camera, GPS, contacts, or other device functions. At step 205, a request to access contacts is made. At step 206, a request to access a camera is made. At step 207, a request to access GPS (or location services) is made.

Turning now to FIG. 2B, at step 208 the user opens the app and at step 209 creates an account (or proceeds as a guest.) At step 210, the user supplies social media credentials to create an account. Other methods of creating an account are possible. At step 211, an instruction video may be shown, if desired. At step 212, a free stamp or credit may be given as a reward for opening the account. The user may be asked to supply a payment method, such as a credit card to the application. Postage purchases may be made on an as-needed basis or postage could be purchased in a block, such as $50.00. If purchases are made in a block, individual postage transactions can be deducted from the available balance.

At step 214, the app can output for display instructions showing a user where to scan the barcode. At step 213, a user may scan a barcode of the pre-printed postage. At step 215, the app validates the scanned barcode. In order to validate the scanned barcode, the application may request information about the unique identifier decoded from the barcode from a central server that tracks the status of pre-printed postage. At step 216, the application can provide feedback if the stamp has already been processed or is otherwise unavailable for use.

The app then requests information on the contents of a package on which the postage is printed or affixed. Where the contents are a greeting card, the user is prompted to scan the barcode (i.e., UPC) of the greeting card at step 217. At step 218, the app can show the user where to scan the UPC. At step 219, the card's barcode can be checked and information about the card can be compared to the envelope to confirm the card fits in the envelope being used, thereby validating the envelope at step 220.

Turning now to FIG. 2C, at step 221, the user is prompted provide information about the destination of the envelope, such as the zip code. This information can be the full address (step 222). At step 223, the information can be optionally pulled from the user's contacts. At step 224, the app can also store previous addresses used in a history file and that information can be provided to the user in order for the user to supply the destination address. At step 225, the entered zip code can be validated for accuracy. At step 226, the user can add extra items, such as gift cards to the envelope. This may cause the postage price to be updated. At step 227, the app can also obtain information from the courier at as to the estimated delivery of the envelope to the entered destination.

Turning now to FIG. 2D, at step 228, the user is prompted to put the card in the envelope and seal the envelope (step 229). At step 230, the app uses the gathered information to calculate the postage due. At step 231, the user can be prompted to see if they need to add extra postage because they have added additional items to the package in step 226. The app can also inform the sender if extra postage is due from the obtained size data.

Once those items are handled, the user is instructed to pay for postage at step 232. At step 234, the user pays for the postage by inputting credit card information. At step 235, the user can be prompted to store the information for future use. At step 236, the user can be asked to create an account, if the user does not already have an account. At step 237, the credit card information is validated. At step 238, the central postage database is updated to indicate that the barcode is paid, but not processed (i.e., previously used).

Turning now to FIG. 2E, at step 239, the app informs the user to not place a stamp on the paid for code. At step 240, the user is prompted to place the envelope in a mailbox for collection. Once in the mail system, the courier (the USPS in this example) validates the barcode at step 241. At step 242, the postage carrier can the update the central postage database to show the barcode as paid and processed.

FIG. 2F illustrates some further steps that can be provided by the app and which are discussed in more detail below. For example, at step 243, the app can track and display the location of the envelope as it moves through the delivery process. This can include alerts to the user as the envelope nears the known destination. At step 244, the recipient, if also an app user, can give feedback to the sender on the card. At step 245, the app can keep a history of the cards sent to each recipient and the timing of the sending. At step 246, the date of the deliver is stored. At step 247, the destination of the delivery is stored. At step 248, this information can be used to help the app user in the future. For example, if the app determines from a previous use and scan that the user sent a birthday card to someone on May 5th, the following year the app may send a notification to the user on April 25th asking if they want to get a birthday card for that person's upcoming birthday. Additions to the app may allow for shopping for that card through the app or directions to a nearby location where cards can be purchased. The app may even suggest cards based off of the previous genres sent to that particular recipient.

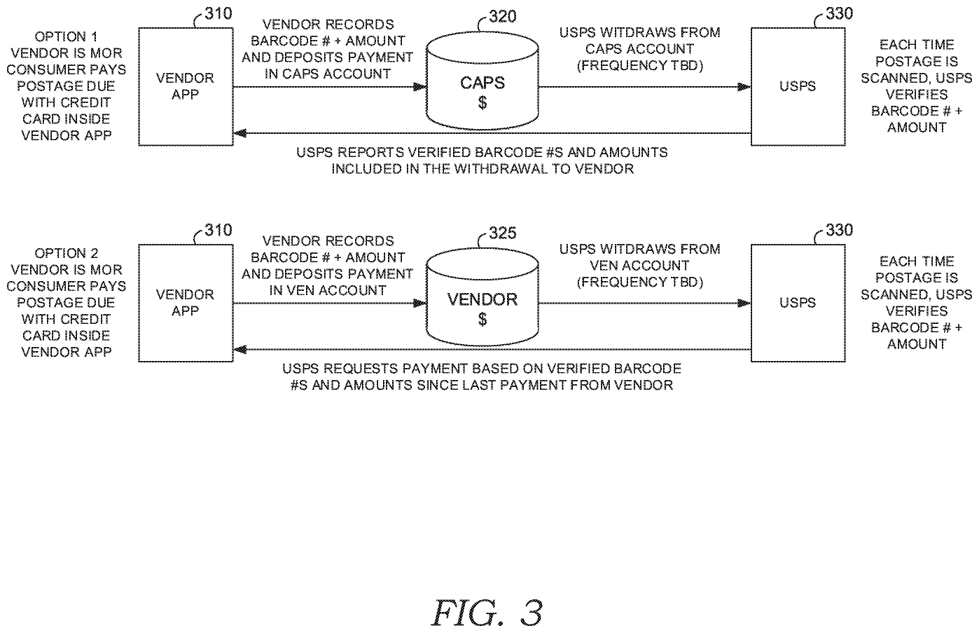

FIG. 3 illustrates various methods for collecting and distributing payment depending on the systems preferred by the app operator (e.g., vendor) or delivery partner. For example, in Option 1, VENDOR is the Merchant of Record (“MOR”). VENDOR, as manufacturer of the envelopes, provides the app 310 and consumers pay postage due in the VENDOR app. VENDOR may establish a Centralized Account Processing System (“CAPS”) 320 account with the USPS (or other carrier). A CAPS account is the USPS's electronic postage payment system. The USPS 330 withdraws money for the verified and processed barcodes from the CAPS account. USPS performs the scanning and verification in the mail process. USPS then reports to VENDOR the barcodes processed and the amounts withdrawn from the CAPS account.

In Option 2, VENDOR creates an account separate from the USPS's CAPS system. USPS still verifies the barcodes and amounts, but then requests payments off of those uses from the VENDOR account.

In addition to the mobile postage application providing for payment of alternative postage, the app can be used to get the sender more involved in the sending process. In that regard, the app can provide a relationship component as well. For example, the app can digitally depict all of the user's activated envelopes as the journey through the mail/delivery process and thereby create for the sender an interactive storytelling experience that strengthens relationships. The interactive storytelling experience includes basic tracking functions, alerts, notifications, reminders, product and content recommendations, as wells as collecting/providing addresses. Over time, the interactive storytelling experience creates cumulative data visualizations of a sender and recipients' connecting loop and relationship growth.

One method of facilitating this connection can occur during the envelope and greeting card scanning process. Here the sender is requested to photograph the greeting card cover or scan the UPC barcode on the back of the card. They are also prompted if a recipient's address should be looked up and/or saved. This process will connect them to a digital address book and/or their universal address book from other platforms if needed. When the address is saved, senders are prompted that other key information could be added such as birthdays. Senders are not required to enter information immediately. The recipient name and relationship may be required, as it is used throughout the storytelling process.

The image of the greeting card or other likeness is then taken through an animated interactive journey that tracks the envelope's progress through the mail to the recipient. Along the way prompts and notifications alert the sender of the delivery path and possibly collects other sender or recipient information in a gamified manner. When the envelope arrives at the physical address, the sender receives a notification and prompt on their phone to return eventually to the app. The app will also receive an on-screen app icon standard notification (e.g., a red badge). When the app is opened, the sender will receive an affirmation animation of their card's impact on the recipient. An example could be an animated greeting card opening and releasing hearts, graduation caps, birthday balloons, and other seasonal/occasion based icons. Other examples could be avatar based with sender and recipients receiving animated badges, totems, tokens, or symbols that transform themselves, objects, or grant them access to various kinds of rewards.

The recipient could also participate by logging on to the app through the envelope or greeting card or through an invitation from the sender. The invitation could be physically noted in the greeting card or sent through a digital interface like a text message or email. The recipient can send digital feedback to the sender in the storytelling experience with similar or same actions/reward as described above.

Over time the interactive storytelling experience creates cumulative data visualizations of sender and recipients connecting loop and relationship growth. For example this could be represented through maps and the building of bridges, or a tree that grows heart shape leaves with each card and changes seasonally, or simple, but fun graphs that tie into the themes of the overall app. The data fueling the visualization will come from the addresses collected and sender/recipient entered information, as well as potential feedback from the delivery provider (e.g., USPS). The sender will receive reminders, notifications, and product/content recommendations based on metadata, key words, and profiling strategies. As senders interact with the app, their collected data and interactions will tailor recommendations and digital storytelling to fit the consumer's personal connecting style.

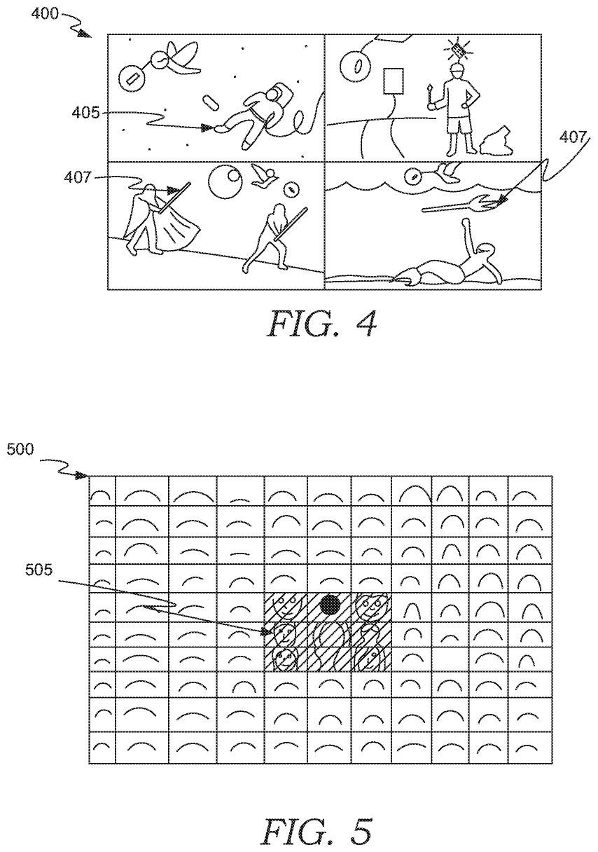

For example, connections could be represented as gifts of digital tools, items, and artifacts providing fantastical or more representative individual enablement based on the personality type of the recipient, as depicted in FIG. 4.

Likewise, a tracking of the relationship could be depicted in a manner that visually conveys information to the user. For example, over time, the relationships affected could be represented as visual avatars of heroes or other characters in an expansive grid with the characters that have strengthened the most near the center, as depicted in FIG. 5.

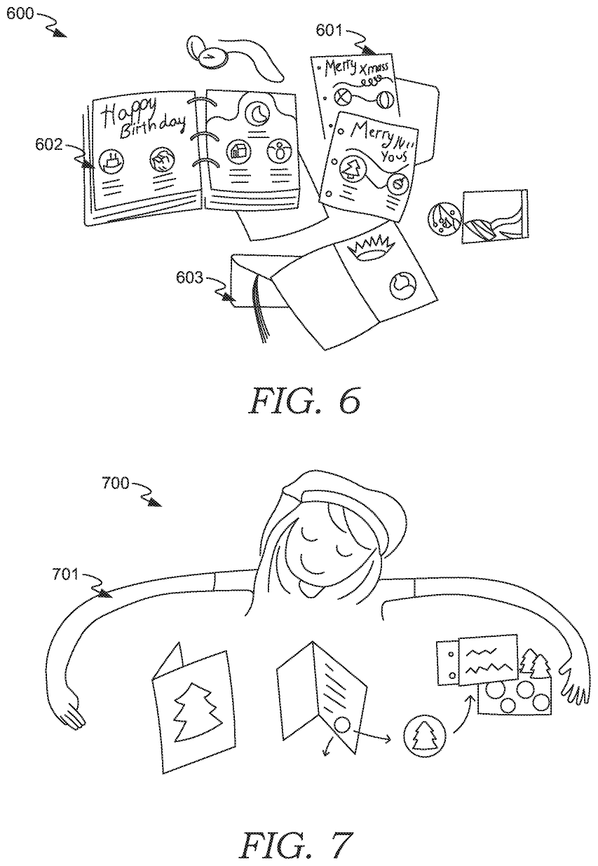

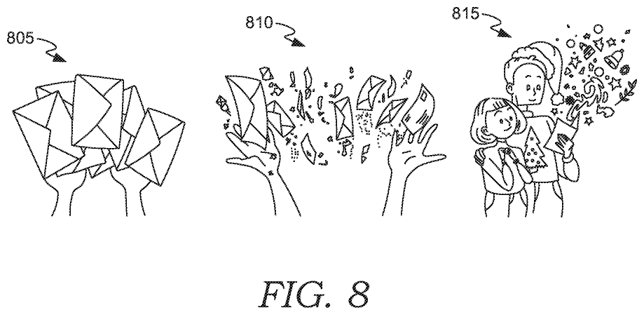

Further, each card sent could be represented through a digital “badge” or “sticker” and as the sender makes these connections, “stickers” can accumulate in a digital archive that can then be revisited as a reminder of the relationship and occasion, as depicted in FIG. 6. As the sender sends greeting cards to people, the caring reach of his or her arms could grow to encompass more people and/or places, as depicted in FIG. 7, below right.

The feelings of warmth, love, support, encouragement, etc. can be represented through environmental icons and the sender's impact on their recipient and/or the region could be shown in the app through a visual spreading of those icons.

For example, while the examples herein talk about the barcode/alternative postage being printed on an envelope, the technology described herein is not limited to such a use. For example, the barcodes may be printed on sheets of labels or packages of labels. Consumers may purchase the labels to apply them to standard blank envelopes or to parcels/packages. The barcode on the label may be used in the same manner as above.

Further, multiple couriers may all be provided access to the database and collect their share of revenues from the postage collected for the packages they deliver. For example, at the start of the app, the user may be provided with a list of all of the couriers available for use through the alternative postage. In one instance the user may select a local messenger to deliver documents to another building. When that option is selected, the user may be asked to enter information specific to that courier and that type of delivery (e.g., pickup time, delivery deadline, etc.). Certain selected couriers may even be able to be notified by the app of a pickup and may be able to notify the sender through the app that they are almost at the pickup location. Once that service scans the barcode on the label, the fees collected to activate that barcode for the service are associated with that courier. In this manner the barcodes on the labels may be used for many different services from many different service providers. These modifications and others are contemplated by and is within the scope of the technology described herein.

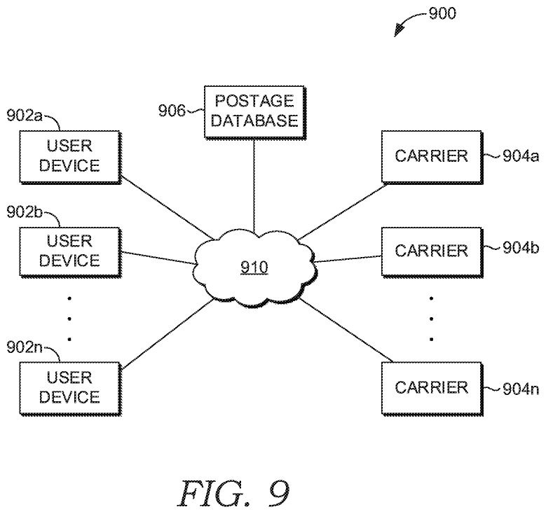

Turning now to FIG. 9, a block diagram is provided showing an operating environment 900 in which aspects of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

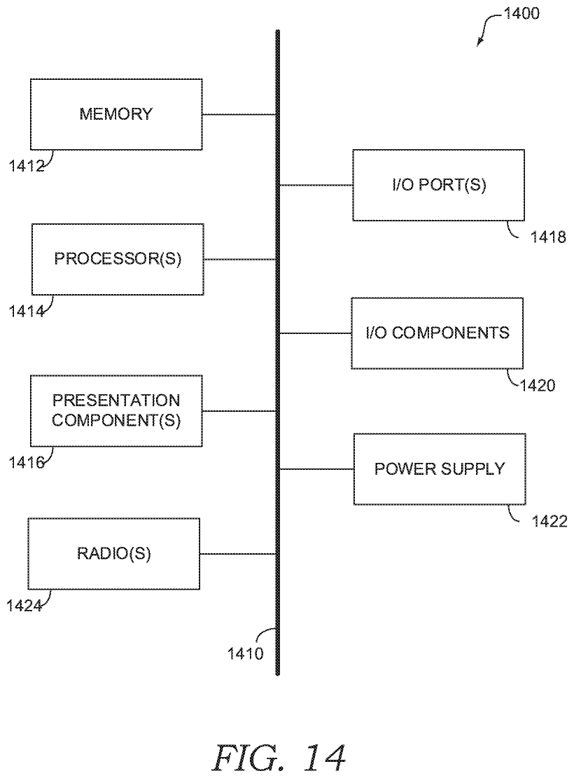

Among other components not shown, example operating environment 900 includes a number of user devices, such as user devices 902a and 902b through 902n; a number of carrier locations, such as carriers 904a and 904b through 904n; postage-payment service 906; and network 910. It should be understood that environment 900 shown in FIG. 9 is an example of one suitable operating environment. Each of the components shown in FIG. 9 may be implemented via any type of computing device, such as computing device 1400, described in connection to FIG. 14, for example. These components may communicate with each other via network 910, which may include, without limitation, one or more local area networks (LANs) and/or wide area networks (WANs). In exemplary implementations, network 910 comprises the Internet and/or a cellular network, amongst any of a variety of possible public and/or private networks.

It should be understood that any number of user devices, servers, and carrier locations may be employed within operating environment 900 within the scope of the present disclosure. Each may comprise a single device or multiple devices cooperating in a distributed environment. For instance, postage-payment service 906 may be provided via multiple devices arranged in a distributed environment that collectively provide the functionality described herein. As an example, the postage-payment service 906 may be a group of servers located at one or more different data centers. Additionally, other components not shown may also be included within the distributed environment.

User devices 902a and 902b through 902n can be client devices on the client-side of operating environment 900, while postage-payment service 906 can be on the server-side of operating environment 900. Postage-payment service 906 can comprise server-side software designed to work in conjunction with client-side software on user devices 902a and 902b through 902n so as to implement any combination of the features and functionalities discussed in the present disclosure. This division of operating environment 900 is provided to illustrate one example of a suitable environment, and there is no requirement for each implementation that any combination of postage-payment service 906 and user devices 902a and 902b through 902n remain as separate entities.

User devices 902a and 902b through 902n may comprise any type of computing device capable of use by a user. The user devices may be personal devices, such as phones, tablets, or laptops or public devices, such as a computer associated with a postage payment kiosk. For example, in one aspect, user devices 902a through 902n may be the type of computing device described in relation to FIG. 14 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where postage may be activated.

Carrier locations 904a and 904b through 904n may comprise physical facilities for receiving and processing postal items, such as letters and packages. For example, a post office is an example of a single carrier location. The carrier location can include mechanical sorting equipment and postal processing equipment that validates the pre-printed postage and then routes the item associated with the pre-printed postage to its destination, possibly a second carrier location. The carrier locations can comprise computing systems that connect to the postage-payment service 906.

The postage-payment service or vendor manages a postage-payment service 906 that tracks the status of pre-printed postage. Initially, the central database of the postage-payment service 906 can be populated with a plurality of pre-printed postage records. Each record can comprise a unique identifier associated with a single instance of pre-printed postage. Other fields in the record can include a postage value associated with the record, the destination ZIP Code, date of payment, date the postage was processed by the postage-payment service 906, a status field indicating the postage was processed by the postage-payment service 906, and the like. The postage database may be implemented across a series of servers in multiple data centers. The postage-payment service 906 can also interface with different payment systems, as needed.

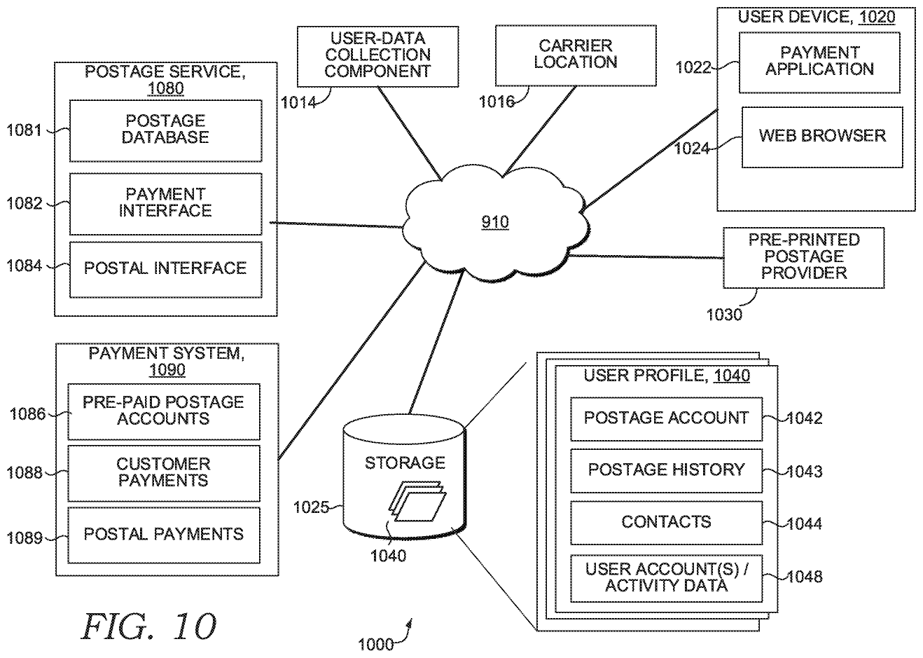

Operating environment 900 can be utilized to implement one or more of the components of system 1000, described in FIG. 10, including components for collecting user data, monitoring communication events, generating modified notifications, and/or presenting notifications and related content to users.

Referring now to FIG. 10, with FIG. 10, a block diagram is provided showing aspects of an example computing system architecture suitable for implementing an aspect of the technology and designated generally as system 1000. System 1000 represents only one example of a suitable computing system architecture. Other arrangements and elements can be used in addition to or instead of those shown, and some elements may be omitted altogether for the sake of clarity. Further, as with operating environment 900, many of the elements described herein are functional entities that may be implemented as discrete or distributed components or in conjunction with other components, and in any suitable combination and location.

Example system 1000 includes network 910, which is described in connection to FIG. 9, and which communicatively couples components of system 1000 including user-data collection component 1014, carrier location 1016, user device 1020, pre-printed postage provider 1030, postage-payment service 1080, payment system 1090, and storage 1025. Postage-payment service 1080 (including its components 1081, 1082, and 1083), user-data collection component 1014, and payment system 1090 (including its components 1086, 1088, and 1089) may be embodied as a set of compiled computer instructions or functions, program modules, computer software services, or an arrangement of processes carried out on one or more computer systems, such as computing device 1400 described in connection to FIG. 14, for example.

In one aspect, the functions performed by components of system 1000 are associated with one or more personal assistant applications, services, or routines. In particular, such applications, services, or routines may operate on one or more user devices (such as user device 902a), servers (such as service 906), may be distributed across one or more user devices and servers, or be implemented in the cloud. Moreover, in some aspects, these components of system 1000 may be distributed across a network, including one or more servers (such as service 906) and client devices (such as user device 902a), in the cloud, or may reside on a user device such as user device 902a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 1000, it is contemplated that in some aspects functionality of these components can be shared or distributed across other components.

Continuing with FIG. 10, user-data collection component 1014 is generally responsible for accessing or receiving (and in some cases also identifying) user data from one or more data sources. The user data can include a history of postage purchases, destination information, product purchases, account information, social network information, payment information, and other information related to pre-printed postage. In some aspects, user-data collection component 1014 may be employed to facilitate the accumulation of user data of one or more users for the pre-printed postage-payment service 1080. The data may be received (or accessed), and optionally accumulated, reformatted, and/or combined, and stored in one or more data stores such as storage 1025, where it may be available to pre-printed postage-payment service 1080. For example, the user data may be stored in or associated with a user profile 1040, as described herein.

The user profile 1040, is stored in a variety of information gleaned from a user's purchase of pre-printed postage, postage activity, purchase activity, and other related activity. The user may be provided opt in or opt out interface where the information being stored in a user profile is explained to the user. The user may be given the option to exclude various data sources or data from the user profile. The user may be given the option to delete existing records, correct information, and provide feedback about the information in the user profile.

The user information can include details about a postage account 1042. Postage account 1042 helps facilitate payment of postage. The postage account 1042 may comprise a user ID and password. The postage account 1042 can also be associated with various payment methods. The postage account 1042 can include unique identifiers for different user devices. Information such as a home address, work address, application versions, email addresses, phone numbers, and the like may also be stored in the postage account 1042.

The postage account 1042 can facilitate a prepaid pre-printed postage account. The user may pay in advance for an amount of postage. In this scenario, the postal value assigned to pre-printed postage is debited from the prepaid account upon payment. The user may receive notices when the account value passes below a threshold. The user may be given the option of replenishing the account through the payment application when a pre-printed postage instance is being activated and the prepaid account falls below a threshold.

The postage history 1043 stores a record of postage purchased, destinations the purchased postage was used to send items to, and any other information about the user's use or purchase of pre-printed postage.

The contacts record 1044 may comprise a contacts record accessible to a payment application residing on a user device. In one instance, the user gives the payment application permission to access the contacts on the user device. In another instance, the contacts 1044 are from a separate source, such as the destination addresses used on pre-printed postage. The contacts 1044 can include social media contacts, work contacts, or other contacts affiliated with the user.

The user accounts activity data 1048 provides information about one or more separate accounts, such as email or social media accounts. In one aspect, a user is able to authenticate himself to the payment system using social media credentials. If the user selects this authentication method, then the credentials may be associated with the user profile 1040.

The pre-printed postage provider 1030 can provide pre-printed postage in a number of formats. In one aspect, the pre-printed postage provider 1030 is an entity that prints pre-printed postage on envelopes, stickers, or other media. A postage provider 1030 can contract with one or more carriers for the pre-printed postage to be valid. Unlike stamps, the pre-printed postage could be accepted by multiple carriers. Multiple carriers could access the pre-printed postage-payment service 1080 and receive compensation recording an instance of pre-printed postage use and seeking compensation from the pre-printed postage provider 1030.

The pre-printed postage provider 1030 can also provide a payment application 1022 and the payment system 1090. Further, the postage-payment service 1080 can be set up and run by the pre-printed postage provider 1030. The pre-printed postage provider 1030 can take an interest in individual transactions. For example, the pre-printed postage provider 1030 can agree to make up the difference between a postage value assigned to a pre-printed postage instance and a calculated postage rate charged by the carrier for the item associated with the instance. Similarly, the pre-printed postage provider 1030 can manage the user profiles 1040, and other aspects of the system.

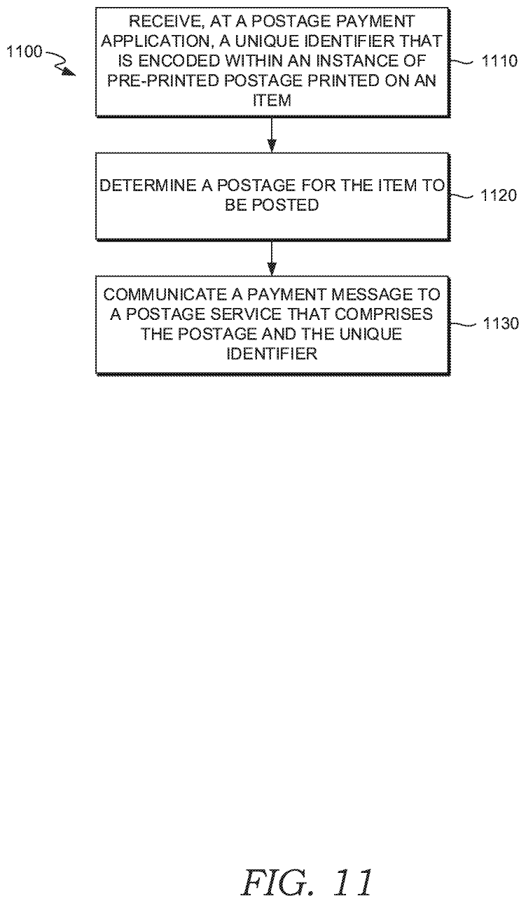

The user device 1020 comprises a payment application 1022 and a web browser 1024 among many other components not shown. The user device 1022 can be similar to the user devices 902a described previously with reference to FIG. 9. Both the payment application 1022 and the web browser 1024 may be used to activate postage through the user device 1020. In either instance, aspects of the payment process may be performed by components operating a computing devices apart from the user device 1020. FIG. 11 describes a postage payment method that could be performed by the user device 1020.

Turning now to FIG. 11, a method 1100 for of paying for postage from a computing device is provided. The computing device may be a user device, such as described previously reference to user device 1020. The payment process of method 1100 may utilize a payment application running on a computing device. The payment process may use a web browser or other application to access a web page through which the postage may be activated according to the steps described below. In one aspect, the computing device is a user device such as a smart phone, PC, or tablet. In another aspect, the computing device is part of a kiosk provided in a public location, such as a post office or store. In one aspect, a payment kiosk is provided within or nearby a stationary section of a drug store, grocery store, or other store where greeting cards and other stationary may be purchased.

Initially, the user may gain access to a payment application. In one example, the user downloads and installs a payment application on his or her user device. In another aspect, the user accesses an application through a webpage. In yet another example, the user accesses a payment application at a publicly available computing device. The payment application may ask the user to login with credentials and follow an authentication process. As part of this process user information may need to be provided as described previously.

The payment application can guide the user through the payment process with tips or prompts for various steps displayed through a graphical user interface. Initially, the user may be prompted to scan the pre-printed postage the user wants to activate. The user can scan the pre-printed postage using the camera on the user device. The user interface may show a camera view in a portion of the screen to help the user see where the camera is pointed. Once an adequate image is captured, the user may be informed the scanning process is complete.

At a minimum, the pre-printed postage comprises unique identifier encoded in a machine-readable format, such as a QR code. As mentioned, the pre-printed postage may be affixed to an envelope or other item. The pre-printed postage could be printed on a sticker that can in turn be affixed to the item to be posted. The pre-printed postage may also have a human readable alphanumeric string to help the user differentiate between different instances of pre-printed postage. The human readable alphanumeric string may be related to the unique identifier or completely separate. For example, the string could be the last five characters of the unique string. Pre-printed postage may also comprise a watermark or other security mark to help prevent forgeries.

At step 1110, a unique identifier that is encoded within an instance of pre-printed postage printed on an item is received at a postage payment application. In one aspect, the unique identifier is retrieved by scanning the pre-printed postage. For example, the camera on a smart phone may capture an image of the pre-printed postage. The image can be provided by the camera to the payment application which decodes the unique identifier from the machine-readable format in which it is encoded. In another aspect, a decoding utility on the phone is accessed by the payment application to decode the unique identifier.

At step 1120, a postage rate required for the item to be posted is determined. The user can be prompted to provide information about the item to be posted in order to calculate the postage rate. The information can include a size and weight of the item, the number of paper sheets being put in the envelope, whether a gift card is being includes, and the like. Alternatively, the payment application can provide examples for the user to select in order to estimate a size and weight. For example, a user can be asked to select images of envelopes having different sizes with different amounts of paper in each envelope. Every size combination does not need to be provided, instead representative sizes and amounts of paper can be used to estimate the appropriate postage rate for the item.

In one aspect, a UPC label on a greeting card or other commercial product may be scanned to retrieve a size and weight of the item. The payment application may prompt the user to scan the UPC label on greeting card or other item. The payment application may look up information about a commercial product from a database. The payment application may use a backend service to perform this function. Alternatively, the payment application may have a local record of some UPC labels and corresponding postal information. The user may also be asked to provide a destination address. In one aspect, the payment application includes the ability to read handwriting. In this instance, the destination address could be obtained by scanning the address listed on the item. In another aspect, an address can be selected from the user's contact information. User may be transferred to a contact interface on the user device in order to select a contact and corresponding address. The user may be asked to select different postal options, such as first-class mail, express shipping, next day delivery, media mail, or some other option.

Once the item information is provided and postal options selected, the postage rate is calculated. The user may be asked to confirm the amount or authorize payment in the amount of the calculated postage rate. A postal value equal to the postage rate will then be associated with the pre-printed postage.

At step 1130, a payment message is communicated to a postage database that tracks the payments received for individual instances of pre-printed postage. The payment message may comprise a postage value equal to the postage rate and the unique identifier. If specific postage for an item is not calculated, then the payment message need not include the value. The service updates a central database to associate the unique identifier with a postal value equal to the postage rate. Other information may also be included within the message, such as a destination ZIP Code and user ID of the user paying for the postage.

In the event of a miscalculation of the postage rate, the user may pre-authorize the central postage database to charge the user a difference between the postage rate and a postage rate subsequently calculated by the carrier.

Returning to FIG. 10, payment for the postage value assigned to a pre-printed postage instance can be processed by the payment system 1090. In one aspect, user's for entities such as companies, pay in advance to create a pre-paid postage account. These accounts are managed by the pre-paid account component 1086. The prepaid postage account component can track the balance in various accounts and provide balance updates to users.

The customer payment component 1088 is responsible for receiving funds from customers paying for postage. The customer payments component 1088 can receive payment from credit cards and other payment methods. The customer payment component 1088 can control the timing of customer payments. In one aspect, customer charges on a credit card are accumulated for an hour, day or some other time, and passed along as a group. In one aspect, charges are accumulated so long as an active application session is ongoing. An active application session may be ongoing when the payment process is open and continues to receive input without an interruption lasting longer than a threshold duration, such as five minutes. At the conclusion of the payment session, the sum of all postage values added to pre-printed postage during the session are charged as a lump sum to the user's credit card or payment method.

The postal payments component 1089 is responsible for transferring funds to a carrier that received an item posted using pre-printed postage. In one aspect, funds are transferred to the postal payment component 1089 upon payment of an instance of pre-printed postage. In another instance, funds are transferred to the carrier on the carrier providing a message indicating a use of the pre-printed postage instance to the pre-printed postage-payment service 1080.

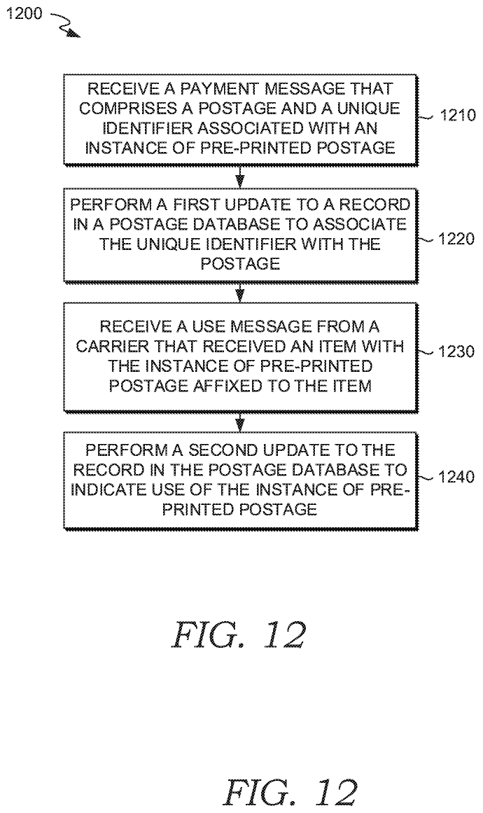

Returning to FIG. 10, the pre-printed postage-payment service 1080 comprises a postage database 1081, a payment interface 1082, and a postal interface 1084. The postage database 1081 includes records for individual instances of pre-printed postage. The information included in each record can vary, but exemplary information includes the unique identifier associated with the instance of pre-printed postage, postage amount associated with the record, a payment status, a date postage was added to the record, carrier identification, carrier location identification, destination information, and user identification information. The payment interface 1082 helps facilitate the payment process for interfacing with a payment application, such as payment application 1022. The payment interface 1082 can receive a payment instruction and provide an instruction to update the postage database 1081 according to the payment instruction. The postal interface 1084 can communicates with the carrier location 1016. The pre-printed postage-payment service 1080 can update the payment status of pre-printed postage, as described with reference to FIG. 12.

Turning now to FIG. 12, a method 1200 for tracking a payment status of pre-printed postage is provided. At step 1210, a payment message that comprises a postage value and a unique identifier associated with an instance of pre-printed postage is received. The payment message may be received from a payment application. The postage value may be calculated by the payment application for a particular item to which pre-printed postage is attached. The unique identifier will correspond with the pre-printed postage attached to the item.

At step 1220, a first update is performed on a record in a postage database to associate the unique identifier with the postage value. Other information may be updated, such as the date of payment, the user associated with the payment, and entity responsible for the pre-printed postage, and the like.

At step 1230, a message is received from a carrier that received an item with the instance of pre-printed postage affixed to the item.

At step 1240, a second update is performed on the record in the postage database to indicate that the instance of pre-printed postage was used. A field maybe provided to describe the payment status of the pre-printed postage instance.

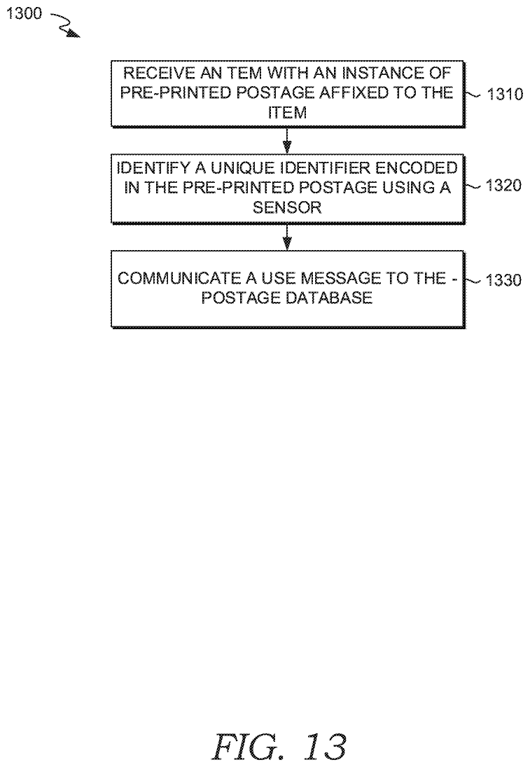

Returning to FIG. 10, the carrier location 1016 can be similar to the carrier locations described previously with reference to FIG. 9. For example, the carrier location 1016 can be a post office. The carrier location 1016 is responsible for receiving and processing items that are posted using pre-printed postage. As part of the processing, the carrier location 1016 track pre-paid postage received by communicating with the pre-printed postage-payment service 1080. FIG. 13 describes a method for tracking the use of pre-printed postage that may be performed by the carrier location 1016.

Turning now to FIG. 13, a method 1300 of processing pre-printed postage is provided.

At step 1310, an item is received with an instance of pre-printed postage affixed to the item. The carrier location, such as a post office, can use automated machinery to process and route items. In one aspect, items having pre-printed postage are identified by scanning the postage on the items.

At step 1320, a unique identifier encoded in the pre-printed postage is identified using a sensor. The unique identifier may be extracted by scanning the pre-printed postage and providing the information obtained to a decoding utility. As mentioned previously, the unique identifier may be encoded as a QR code, barcode, or in some other machine readable format. The scanning method employed is suitable for the encoding method used.

At step 1330, a usage message is communicated to the postage-payment service. Once the carrier has processed the item, a message to record the use of the postage is provided. The message can include the unique identifier as well as relevant information, such as a calculated rate. The calculated rate can act as feedback that helps the payment application improve the postage rate estimates that provides users. The message can include identification of the carrier location. In an aspect, the pre-printed postage-payment service 1080 can interface with multiple carriers. Carriers may receive compensation in the amount of the calculated postage rate upon receiving a deactivation message.

With reference to FIG. 14, computing device 1400 includes a bus 1410 that directly or indirectly couples the following devices: memory 1412, one or more processors 1414, one or more presentation components 1416, one or more input/output (I/O) ports 1418, one or more I/O components 1420, and an illustrative power supply 1422. Bus 1410 represents what may be one or more busses (such as an address bus, data bus, or combination thereof). Although the various blocks of FIG. 14 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 14 is merely illustrative of an exemplary computing device that can be used in connection with one or more aspects of the present technology. Distinction is not made between such categories as “workstation,” “server,” “laptop,” “handheld device,” etc., as all are contemplated within the scope of FIG. 14 and with reference to “computing device.”

Computing device 1400 typically includes a variety of computer-readable media. Computer-readable media can be any available media that can be accessed by computing device 1400 and includes both volatile and nonvolatile media, removable and non-removable media. By way of example, and not limitation, computer-readable media may comprise computer-storage media and communication media.

Computer-storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1400. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1412 includes computer storage media in the form of volatile and/or nonvolatile memory. The memory may be removable, non-removable, or a combination thereof. Exemplary hardware devices include solid-state memory, hard drives, optical-disc drives, etc. Computing device 1400 includes one or more processors 1414 that read data from various entities such as memory 1412 or I/O components 1420. Presentation component(s) 1416 presents data indications to a user or other device. Exemplary presentation components include a display device, speaker, printing component, vibrating component, and the like.

The I/O ports 1418 allow computing device 1400 to be logically coupled to other devices, including I/O components 1420, some of which may be built in. Illustrative components include a microphone, joystick, game pad, satellite dish, scanner, printer, wireless device, etc.

The I/O components 1420 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1400. The computing device 1400 may be equipped with depth cameras, such as stereoscopic camera systems, infrared camera systems, RGB camera systems, and combinations of these, for gesture detection and recognition. Additionally, the computing device 1400 may be equipped with accelerometers or gyroscopes that enable detection of motion. The output of the accelerometers or gyroscopes may be provided to the display of the computing device 1400 to render immersive augmented reality or virtual reality.

Some aspects of computing device 1400 may include one or more radio(s) 1424 (or similar wireless communication components). The radio 1424 transmits and receives radio or wireless communications. The computing device 1400 may be a wireless terminal adapted to receive communications and media over various wireless networks. Computing device 1400 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Aspects of the present technology have been described with the intent to be illustrative rather than restrictive. Alternative aspects will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A method for of paying for postage from a computing device, comprising:
receiving, at a postage-payment application, a unique identifier that is encoded within an instance of pre-printed postage printed on an item;
determining a postage rate required for the item to be posted; and
communicating a payment message to a postage-payment service that comprises a postage value equal to the postage rate and the unique identifier.

2. The method of claim 1, wherein the item is an envelope and said determining the postage rate comprises receiving an indication from a user indicating that a gift card is to be posted within the envelope.

3. The method of claim 1, wherein said determining the postage rate comprises identifying a greeting card to be sent in the item by scanning the greeting card and looking up shipment information for the greeting card in a greeting card database.

4. The method of claim 3, wherein the greeting card is identified through computer vision analysis of a visual design on the greeting card.

5. The method of claim 3, wherein the greeting card is identified through identification of a Universal Product Code (UPC) on the greeting card.

6. The method of claim 1, wherein the postage-payment application is running on a smart phone.

7. The method of claim 1, wherein the instance of pre-printed postage comprises a non-human readable forgery prevention mark that is machine readable by a carrier's item processing device.

8. A method for tracking a payment status of pre-printed postage, comprising:
receiving a payment message that comprises a postage value and a unique identifier associated with an instance of pre-printed postage;
performing a first update to a record in a postage-payment service to associate the unique identifier with the postage value;
receiving a use message from a carrier that received an item with the instance of pre-printed postage affixed to the item; and
performing a second update to the record in the postage-payment service to indicate the instance of pre-printed postage was used.

9. The method of claim 8, wherein the method further comprises, subsequent to performing the second update, transferring payment for the postage value to the carrier.

10. The method of claim 8, wherein the unique identifier was in the postage-payment service database prior to receiving the use message.

11. The method of claim 8, wherein the use message also identifies a purchaser of the instance of pre-printed postage and destination information.

12. The method of claim 8, further comprising sending a message to a payment system indicating that the instance of pre-printed postage has been processed by the carrier.

13. The method of claim 8, wherein the payment message is received from a computing device associated with a user of the instance of the pre-printed postage.

14. The method of claim 13, wherein the record in the postage-payment service comprises an indication that the pre-printed postage has been printed.

15. A method of processing pre-printed postage, the method comprising:
receiving an item with an instance of pre-printed postage affixed to the item;
identifying a unique identifier encoded in the instance of pre-printed postage using a sensor;
communicating a use message to a postage-payment service database.

16. The method of claim 15, wherein the use message is communicated by a carrier.

17. The method of claim 15, wherein the unique identifier is associated with a postage value in the postage-payment service database.

18. The method of claim 15, further comprising receiving a payment in an amount of the postage value in response to the use message.

8. The method of claim 15, wherein the method further comprises routing the item to a destination upon determining the postage value is equal to or greater than a correct postage rate.

20. The method of claim 15, wherein the sensor is a visual sensor.
